(19) United States
(12) Patent Application Publication
(10) Pub. No.: US 2022/0162428 A1
(43) Pub. Date: May 26, 2022

(54) POLYOLEFIN RESIN COMPOSITION

(71) Applicants: HYUNDAI MOTOR COMPANY, SEOUL (KR); KIA CORPORATION, SEOUL (KR); DAEWON CHEMICAL CO., LTD., CHEONAN-SI (KR)

(72) Inventors: Soo Chul Park, Seoul (KR); Dae Sik Kim, Yongin-si (KR); Hyung Joon Youn, Seoul (KR); Se Jong Hwang, Osan-si (KR); Sang Mok Kim, Cheonan-si (KR); Jin Hyung Jeong, Cheonan-si (KR); Ki Hun Park, Cheonan-si (KR)

(21) Appl. No.: 17/368,038

(22) Filed: Jul. 6, 2021

(30) Foreign Application Priority Data
Nov. 23, 2020 (KR) 10-2020-0157700

(51) Int. Cl. C08L 23/06

(52) U.S. Cl. CPC C08L 23/06; C08L 2205/03

(57) ABSTRACT

The present disclosure relates to a polyolefin resin composition added with an aroma oil capable of being applied to a vehicle interior material for improving the air quality.

### CROSS REFERENCE TO RELATED APPLICATIONS

This application claims under 35 U.S.C. § 119(a) the benefit of priority to Korean Patent Application No. 10-2020-0157700 filed on Nov. 23, 2020, the entire contents of which are incorporated herein by reference.

### BACKGROUND

### (a) Technical Field

The present disclosure relates to a polyolefin resin composition, and more specifically, to a polyolefin resin composition added with an aroma oil capable of being applied to a vehicle interior material or the like for improving the air quality or the like.

### (b) Background Art

In the vehicle interior, a potential safety issue can arise due to volatile organic compounds (VOCs) such as formaldehyde, acetaldehyde, benzene, toluene, xylene, ethylbenzene, and styrene generated through interior materials, and further, the volatile organic compounds (VOCs) may be the source of odors which may cause discomfort for the user. Several attempts have been made to remove such odors, but the most commonly selected method may be a masking effect using a diffusion operation. The product using such a method is the mainstream in the aftermarket, but there is a problem in that a double cost of the consumer is required.

Therefore, there is a need for a method capable of completely removing the odor of a new car by removing the volatile organic compounds in the first vehicle production step.

In the case of the conventional scented resin composition, a technology for retaining the scent using various resins is disclosed and as a carrier for delaying the release of the scent, not only thermosetting resins but also thermoplastic resins are variously used as a carrier for delaying the release of the scent and a carrier oil blending technology is disclosed as in the above patent for the purpose of delaying the release of the scent itself but there is a problem in that the effect thereof does not meet expectations yet.

The above information disclosed in this Background section is only for enhancement of understanding of the background of the disclosure and accordingly it may include information that does not form the prior art that is already known in this country to a person of ordinary skill in the art.

### SUMMARY

An object of the present disclosure is to provide a method for maximizing projection and persistence of the aroma oil.

Another object of the present disclosure is to block odors, which may occur in an air conditioner in summer and in a humid environment, by diffusing scent, thereby improving the air quality inside a vehicle.

Still another object of the present disclosure is to suppress the occurrence of bacteria, which is the cause of odor, through the antibacterial activity possessed by the aroma oil.

The object of the present disclosure is not limited to the aforementioned objects. The object of the present disclosure will be further clarified by the following description, and achieved by the means described in the claims and a combination thereof.

The present disclosure provides a polyolefin resin composition including a polyolefin resin, a styrene copolymer resin, a scented oil, a synergist including at least one of organized nanoclay and surface-treated silica, and an additive.

The polyolefin resin may include one selected from a group consisting of polyethylene, polypropylene, and a combination thereof.

The styrene copolymer may have the weight-average molecular weight of 100,000 or more.

The styrene copolymer may have the viscosity of 90 mPa·s (Toluene solution 5 wt %) or more.

The styrene copolymer resin may include at least one of styrene-ethylene ethylene propylene styrene copolymer, styrene isoprene styrene copolymer, hydrogenated styrene butadiene styrene copolymer, hydrogenated styrene isoprene styrene copolymer, and hydrogenated styrene butadiene isoprene styrene copolymer.

The scented oil may include an aroma oil and a carrier oil comprising one of a paraffin oil and a silicone oil.

A mixing ratio of the aroma oil and the carrier oil may be 1:10 to 1:30 based on the weight.

The surface-treated silica may include the silica surface-treated with lipophilicity.

The additive may include at least one of an inorganic filler, an antioxidant, a lubricant, and a pigment.

The antioxidant may include at least one of the phenol-based antioxidant and the phosphorus-based antioxidant.

The polyolefin resin composition may include 43.5 to 98.85 wt % of the polyolefin resin, 0.1 to 5 wt % of the styrene copolymer resin, 0.1 to 5 wt % of the scented oil, 0.1 to 5 wt % of the synergist, and 0.1 to 41.5 wt % of the additive.

The present disclosure may provide the method for maximizing the projection and persistence of the scent of the aroma oil.

The present disclosure may block the odors in a humid environment by using diffusing scent, thereby improving the air quality inside the vehicle.

The present disclosure may suppress the occurrence of bacteria, which is the cause of odor, through the antibacterial activity possessed by the aroma oil.

The effect of the present disclosure is not limited to the aforementioned effects. The effect of the present disclosure should be understood as including all effects inferable from the following description.

It is understood that the term “automotive” or “vehicular” or other similar term as used herein is inclusive of motor automotives in general such as passenger automobiles including sports utility automotives (operation SUV), buses, trucks, various commercial automotives, watercraft including a variety of boats and ships, aircraft, and the like, and includes hybrid automotives, electric automotives, plug-in hybrid electric automotives, hydrogen-powered automotives and other alternative fuel automotives (e.g., fuels derived from resources other than petroleum). As referred to herein, a hybrid automotive is an automotive that has two or more sources of power, for example both gasoline-powered and electric-powered automotives.

### DETAILED DESCRIPTION

As described above, objects, other objects, features, and advantages according to the present disclosure will be readily understood through the following preferred exemplary embodiments associated with the accompanying drawings. However, the present disclosure is not limited to the exemplary embodiments described herein and may also be embodied in other forms. Rather, the exemplary embodiment introduced herein are provided so that the disclosure may be thorough and complete, and the spirit according to the present disclosure may be sufficiently conveyed to those skilled in the art.

In this specification, it should be understood that terms such as “comprise” or “have” are intended to indicate that there is a feature, a number, a step, an operation, a component, a part, or a combination thereof described on the specification, and do not exclude the possibility of the presence or the addition of one or more other features, numbers, steps, operations, components, parts, or combinations thereof in advance. Further, when a portion such as a layer, a film, an area, or a plate is said to be “on” another portion, this includes not only the case where the portion is “directly above” another portion but also the case where other portions are interposed therebetween. Conversely, when a portion such as a layer, a film, an area, or a plate is said to be “under” another portion, this includes not only the case where the portion is “directly under” another portion but also the case where other portions are interposed therebetween.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values. Further, where a numerical range is disclosed herein, such a range is continuous, and includes unless otherwise indicated, every value from the minimum value to and including the maximum value of such range. Still further, where such a range refers to integers, unless otherwise indicated, every integer from the minimum value to and including the maximum value is included.

In the present specification, if a range is described for a variable, it will be understood that the variable includes all values within the described range including the described endpoints of the range. For example, it will be understood that a range of “5 to 10” includes not only values of 5, 6, 7, 8, 9, and 10 but also any sub-range such as 6 to 10, 7 to 10, 6 to 9, and 7 to 9, and also includes any value between reasonable integers within the scope of the described ranges such as 5.5, 6.5, 7.5, 5.5 to 8.5, 6.5 to 9, and the like. Further, it will be understood that a range of “10% to 30%” includes, for example, not only all integers including values, such as 10%, 11%, 12%, and 13%, and 30% but also any sub-range such as 10% to 15%, 12% to 18%, and 20% to 30%, and also includes any value between reasonable integers within the scope of the described range, such as 10.5%, 15.5%, and 25.5%.

The present disclosure relates to a polyolefin resin composition, in which the polyolefin resin composition includes a synergist including at least one of polyolefin resin, styrene copolymer resin, scented oil, organic nanoclay, and surface-treated silica, and additives.

The polyolefin resin may include polyethylene and polypropylene, but is not limited thereto, and a resin capable of extrusion molding, injection molding, or the like may be sufficient.

The polyolefin resin composition according to the present disclosure preferably includes 43.5 to 98.85 wt % of the polyolefin resin.

The scented oil according to the present disclosure is characterized by including the aroma oil and the carrier oil.

In the case of the scented oil, it is preferable to distribute the scented oil through the application on the surface of a pellet manufactured by a resin composition configuration according to the present disclosure before molding, in order to apply the present disclosure to the plastic.

The aroma oil preferably has the natural scent or the like, and for example, may have the herb scent or the like.

The carrier oil preferably serves to dilute the aroma oil and serves as the medium which helps the aroma oil to scent the entire polyolefin resin.

Without the carrier oil, the aroma oil may not be evenly distributed to the entire polyolefin resin composition, such that the aroma scent generated by the molding product manufactured by the polyolefin resin composition may be unevenly generated according to the location.

The carrier oil is mixed with the aroma oil to form a mixture, and preferably serves to increase the boiling point of the formed mixture. Here, the aroma oil and the carrier oil are preferably mixed by the mechanical mixing using agitation, ultrasonic treatment, or the like. As described above, the phenomenon in which the boiling point of the scented oil having different materials evenly mixed is elevated is called a boiling point elevation phenomenon. The boiling point elevation phenomenon is the phenomenon caused by the lower steam pressure of the scented oil than that of the pure material having the same temperature.

In the present disclosure, the boiling point of the carrier oil is higher than the boiling point of the aroma oil. Therefore, in the case of the mixture of two different liquids such as the aroma oil and the carrier oil, the boiling point elevation phenomenon occurs in the aroma oil having the low boiling point. As described above, since the boiling point of the aroma oil may be elevated by using the carrier oil, the steam pressure of the aroma oil may be lowered even in the high-temperature molding temperature, thereby reducing an amount of aroma oil removed or decomposed by being evaporated by the high temperature. However, if the boiling point of the carrier oil is lower than the boiling point of the aroma oil, the boiling point elevation phenomenon of the aroma oil does not occur, such that it is difficult to reduce an amount of aroma oil removed or decomposed in the molding temperature, and the decomposed amount of the carrier oil having the low boiling point may be increased, thereby becoming the cause of lowering the physical property of the plastic.

Meanwhile, a mixing ratio of the mixture of the aroma oil and the carrier oil included in the scented oil is preferably 1:10 to 1:30 based on the weight. If the mixing ratio is less than 1:10, the content of the carrier oil is too little, such that it is difficult to evenly distribute the aroma oil and as a result, it is difficult to evenly mix the aroma oil and the carrier oil in the plastic. On the other hand, if the mixing ratio exceeds 1:30, the content of the carrier oil is too much, such that there is a problem in that the effect of the aroma oil is almost removed.

The carrier oil preferably includes one of a paraffin oil and a silicone oil.

The polyolefin resin composition according to the present disclosure preferably includes 0.1 to 5.0 wt % of the scented oil, and more preferably, includes 0.1 to 1.0 wt % of the scented oil.

At this time, if the content of the polyolefin resin composition is less than 0.1 wt %, the scented effect may be insignificant and if the content of the polyolefin resin composition exceeds 5.0 wt %, the mechanical physical property of the molding product is rapidly lowered.

The styrene copolymer resin according to the present disclosure may have preferably the weight-average molecular weight of 100,000 or more.

The styrene copolymer resin may have preferably the viscosity of 90 mPa·s (Toluene solution 5 wt %) or more.

The styrene copolymer resin includes at least one of styrene-ethylene ethylene propylene styrene copolymer (SEEPS), styrene-isoprene-styrene block copolymer (SIS), hydrogenated styrene butadiene copolymer (hSBS), hydrogenated styrene-isoprene-styrene copolymer (hSIS), and hydrogenated styrene-butadiene-isoprene-styrene copolymer (hSBIS).

The polyolefin resin composition according to the present disclosure preferably includes 0.1 to 5 wt % of the styrene copolymer resin.

The synergist according to the present disclosure includes at least one of the organized nanoclay and the surface-treated silica.

The surface-treated silica is preferably surface-treated with lipophilic.

The polyolefin resin composition according to the present disclosure preferably includes 0.1 to 5.0 wt % of the synergist.

The additive according to the present disclosure may include at least one of an inorganic filler, an antioxidant, a lubricant, and a pigment, and these kinds are not specially limited, and may be selected, as necessary.

The antioxidant preferably includes at least one of the phenol-based antioxidant and the phosphorus-based antioxidant.

The polyolefin resin composition according to the present disclosure preferably includes 0.1 to 41.5 wt % of the additive.

Hereinafter, the present disclosure will be described in more detail through the detailed examples. However, these examples are intended to illustrate the present disclosure and the scope of the present disclosure is not limited by these.

### Example 1

The styrene copolymer and the scented oil were mixed at a ratio of 1:1 and left for 0.5 hour and then agitated for 10 minutes using a mixer. Then, the polyolefin resin composition was prepared by additionally mixing the synergist, the antioxidant 1, the antioxidant 2, the lubricant, the polyolefin resin, and the inorganic filler, and a specimen was prepared by extrusion molding. At this time, the polyolefin resin composition included 89.1 wt % of the polyolefin resin, 3 wt % of the styrene copolymer resin (SEEPS), 3 wt % of the scented oil, 3 wt % of the synergist, 0.1 wt % of the antioxidant 1, 0.1 wt % of the antioxidant 2, 0.2 wt % of the lubricant, and 1.5 wt % of the pigment.

### Example 2, Comparative Example 1 to Comparative Example 4

The polyolefin resin composition was prepared by a combination of the components expressed in Table 1 below in the same method as that of the Example 1, and each specimen was prepared by molding the same.

TABLE 1

| | Example | Example | Comparative | Comparative | Comparative | Comparative |
|---|---|---|---|---|---|---|
| | 1 | 2 | Example 1 | Example 2 | Example 3 | Example 4 |
| Polyolefin | 89.1 | 92.1 | 92.1 | 92.1 | 92.1 | 95.1 |
| Styrene copolymer | 3 | 3 | — | — | — | |
| (SEEPS) | | | | | | |
| Styrene copolymer | — | — | 3 | — | — | — |
| (SEBS) | | | | | | |
| Alpha olefin octene | — | — | — | 3 | — | — |
| copolymer (POE) | | | | | | |
| Alpha olefin diene | — | — | — | — | 3 | — |
| copolymer (EDPM) | | | | | | |
| Scented oil | 3 | 3 | 3 | 3 | 3 | 3 |
| Synergist | 3 | — | — | — | — | — |
| Antioxidant 1 | 0.1 | 0.1 | 0.1 | 0.1 | 0.1 | 0.1 |
| Antioxidant 2 | 0.1 | 0.1 | 0.1 | 0.1 | 0.1 | 0.1 |
| Lubricant | 0.2 | 0.2 | 0.2 | 0.2 | 0.2 | 0.2 |
| Pigment | 1.5 | 1.5 | 1.5 | 1.5 | 1.5 | 1.5 |

Polyolefin: polyethylene
Styrene copolymer (SEEPS): Kuraray Septon 4055
Scented oil: peppermint oil
Synergist: Aerosi1R200
Antioxidant 1: Irganox 1010
Antioxidant 2: Irgafos 168
Lubricant: Zn-ST
Pigment: carbon black

### Experimental Example

The scent volatility and odor sensory evaluation was performed for the specimens prepared by the Example 1, the Example 2, and the Comparative Example 1 to the Comparative Example 4 and the result was expressed in Table 2 below.

TABLE 2

| | Example | Example | Comparative | Comparative | Comparative | Comparative |
|---|---|---|---|---|---|---|
| | 1 | 2 | Example 1 | Example 2 | Example 3 | Example 4 |
| Loss ppm(80° C., 2 hr) | 7400 | 11300 | 11900 | 15200 | 15600 | 16200 |
| Loss ppm(120° C., | 14200 | 23000 | 24200 | 30100 | 30400 | 31200 |
| 2 hr) | | | | | | |
| Odor sensory | Very | Strong | Strong | Normal | Normal | Normal |
| evaluation | strong | | | | | |

Loss ppm*: by making the weight of the specimen 65 mg, a change in the weight, which was reduced by heating the specimen for 2 hours in the conditions where the heating speed was 20° C./min, and the isothermal was 80° C. or 120° C. under the nitrogen atmosphere, was observed.
Odor sensory evaluation*: the odor was classified into five stages by leaving the specimen for 2 weeks in the oven of 80° C. and then cooling it for 2 hours and evaluated as very strong, strong, normal, weak, and too weak.

1. A polyolefin resin composition comprising:
a polyolefin resin;
a styrene copolymer resin;
a scented oil;
a synergist comprising either or both of organized nanoclay and surface-treated silica; and
an additive.

2. The polyolefin resin composition of claim 1, wherein the polyolefin resin comprises: one selected from a group consisting of: polyethylene, polypropylene, and a combination thereof.

3. The polyolefin resin composition of claim 1, wherein the styrene copolymer has a weight-average molecular weight of at least 100,000.

4. The polyolefin resin composition of claim 1, wherein the styrene copolymer has the viscosity of at least 90 mPa·s (Toluene solution 5 wt %).

5. The polyolefin resin composition of claim 1, wherein the styrene copolymer resin comprises at least one of: styrene-ethylene ethylene propylene styrene copolymer, styrene isoprene styrene copolymer, hydrogenated styrene butadiene styrene copolymer, hydrogenated styrene isoprene styrene copolymer, and hydrogenated styrene butadiene isoprene styrene copolymer.

6. The polyolefin resin composition of claim 1, wherein the scented oil comprises:
an aroma oil; and
a carrier oil comprising one of a paraffin oil and a silicone oil.

7. The polyolefin resin composition of claim 6, wherein a mixing ratio of the aroma oil and the carrier oil is 1:10 to 1:30 based on a weight of the scented oil.

8. The polyolefin resin composition of claim 1, wherein the surface-treated silica comprises silica surface-treated with lipophilicity.

9. The polyolefin resin composition of claim 1, wherein the additive comprises at least one of: an inorganic filler, an antioxidant, a lubricant, and a pigment.

10. The polyolefin resin composition of claim 9, wherein the antioxidant comprises at least one of: a phenol-based antioxidant and a phosphorus-based antioxidant.

11. The polyolefin resin composition of claim 1, wherein the polyolefin resin composition comprises: 43.5 to 98.85 wt % of the polyolefin resin, 0.1 to 5 wt % of the styrene copolymer resin, 0.1 to 5 wt % of the scented oil, 0.1 to 5 wt % of the synergist, and 0.1 to 41.5 wt % of the additive.
